(19) United States
(12) Patent Application Publication
(10) Pub. No.: US 2020/0032056 A1
(43) Pub. Date: Jan. 30, 2020

(54) PRODUCTS COMPRISING THERMOPLASTICS MODIFIED WITH DISPERSED FLUOROCARBONS

(71) Applicant: RES Development Corporation, Lecanto, FL (US)

(72) Inventor: Robert E. Sterling, Homosassa Springs, FL (US)

(21) Appl. No.: 16/148,063

(22) Filed: Oct. 1, 2018

Related U.S. Application Data
(60) Provisional application No. 62/702,546, filed on Jul. 24, 2018.

(51) Int. Cl. C08L 77/00; B29C 47/00; B29C 47/10; C08J 3/20; C08L 53/02; C08L 23/02

(52) U.S. Cl. CPC C08L 77/00; B29C 47/0004; B29C 47/1027; C08J 3/201; B29K 2021/003; C08L 23/02; B29C 47/0026; B29C 47/0021; C08L 53/02

(57) ABSTRACT

A thermoplastic product, such as a film, tubing, sheeting, and a profile with a cross-section, is made by a process including extruding a melt-blended mixture comprising a thermoplastic polymer and a fluorocarbon additive through an extruding die. The thermoplastic polymer and the fluorocarbon additive are substantially homogenously distributed in the melt-blended mixture before extrusion. Upon cooling, the extruded product forms into a solid thermoplastic product comprising the thermoplastic polymer and the fluorocarbon additive and having a particular shape. The fluorocarbon additive has a lower surface energy than that of the thermoplastic polymer. As a result, a concentration of the fluorocarbon additive through a cross-section of the solid thermoplastic product is lower in the interior thereof and higher at the surfaces thereof. The solid thermoplastic product has a lubricity surface. The thermoplastic product having lubricity surfaces may be further flexible and/or elastic, or non flexible.

### CROSS-REFERENCE TO RELATED APPLICATION

This application claims benefit of priority of U.S. Provisional Patent Application No. 62/702,546, filed Jul. 24, 2018. The entire contents and disclosures of this patent application is incorporated herein by reference in its entirety.

### BACKGROUND

### Field of the Invention

The present invention relates generally to thermoplastic products. More particularly, the present invention relates to thermoplastic products prepared by an extrusion process screw, ram and pull extrusion.

Today, many applications require improved performance of polymer products. The ever-changing transmission movement of: gases, liquids and certain fluids through polymer tubing has placed demands for increased performance of polymer tubing. In addition, there is also a need for other flexible polymer products such as films, sheets, and profiles that have resiliency and surface lubricity.

### SUMMARY

According to first broad aspect, the present invention provides a thermoplastic product made by a process comprising: extruding a melt-blended mixture comprising an thermoplastic polymer and a fluorocarbon additive through an extruding die, thereby producing an extrudate. The extrudate comprising the thermoplastic polymer and the fluorocarbon additive. The extrudate is cooled to form a solid thermoplastic product comprising the thermoplastic polymer and the fluorocarbon additive and having a particular shape. It should be appreciated that the thermoplastic polymer and the fluorocarbon additive are substantially homogenously distributed in the melt-blended mixture; the fluorocarbon additive has a lower surface energy than that of the thermoplastic polymer; a concentration of the fluorocarbon additive through a cross-section of the solid thermoplastic product is lower in the interior thereof and higher at the surfaces thereof; and the solid thermoplastic product is flexible and/or elastic and has a lubricity surface.

According to a second broad aspect, the present invention provides a method of forming a thermoplastic product comprising: melt-blending an thermoplastic polymer and a fluorocarbon additive at a temperature for a sufficient time to produce a substantially homogenous blend of the thermoplastic polymer and the fluorocarbon additive; extruding the substantially homogenous blend through an extruding die, thereby forming an extrudate comprising the thermoplastic polymer and the fluorocarbon additive; and cooling the extrudate to allow the extrudate forms into a solid thermoplastic product having the particular shape; wherein the temperature is above a glass transition temperature or a softening point of the thermoplastic polymer but below a point that has a deleterious effect on the thermoplastic polymer and the fluorocarbon additive; wherein a concentration of the fluorocarbon additive through a cross-section of the solid thermoplastic product is lower in the interior thereof and higher at surfaces thereof; and wherein the solid thermoplastic product is and has a lubricity surface.

### BRIEF DESCRIPTION OF THE DRAWINGS

The accompanying drawings, which are incorporated herein and constitute part of this specification, illustrate exemplary embodiments of the invention, and, together with the general description given above and the detailed description given below, serve to explain the features of the invention.

FIG. 1 is a schematic illustration showing a fragment of tubing according to one embodiment of the present invention.

FIG. 2 is a cross-sectional view of the tubing in FIG. 1 according to one embodiment of the present invention.

FIG. 3 is a schematic illustration showing a profile having a fixed cross-sectional pattern according to one embodiment of the present invention.

FIG. 4 is a schematic illustration showing a film according to one embodiment of the present invention.

FIG. 5 is a schematic illustration showing a sheet according to one embodiment of the present invention.

### DETAILED DESCRIPTION OF THE INVENTION

Definitions

Where the definition of terms departs from the commonly used meaning of the term, applicant intends to utilize the definitions provided below, unless specifically indicated.

It is to be understood that the foregoing general description and the following detailed description are exemplary and explanatory only and are not restrictive of any subject matter claimed. In this application, the use of the singular includes the plural unless specifically stated otherwise. It should be noted that, as used in the specification and the appended claims, the singular forms “a,” “an” and “the” include plural referents unless the context clearly dictates otherwise. In this application, the use of “or” means “and/or” unless stated otherwise. Furthermore, use of the term “including” as well as other forms, such as “include”, “includes,” and “included,” is not limiting.

It is to be understood that the foregoing general description and the following detailed description are exemplary and explanatory only and are not restrictive of any subject matter claimed. In this application, the use of the singular includes the plural unless specifically stated otherwise. It must be noted that, as used in the specification and the appended claims, the singular forms “a,” “an” and “the” include plural referents unless the context clearly dictates otherwise. In this application, the use of “or” means “and/or” unless stated otherwise. Furthermore, use of the term “including” as well as other forms, such as “include”, “includes,” and “included,” is not limiting.

It is to be understood that the foregoing general description and the following detailed description are exemplary and explanatory only and are not restrictive of any subject matter claimed. In this application, the use of the singular includes the plural unless specifically stated otherwise. It must be noted that, as used in the specification and the appended claims, the singular forms “a,” “an” and “the” include plural referents unless the context clearly dictates otherwise. In this application, the use of “or” means “and/or” unless stated otherwise. Furthermore, use of the term “including” as well as other forms, such as “include”, “includes,” and “included,” is not limiting.

For purposes of the present invention, the term “comprising”, the term “having”, the term “including,” and variations of these words are intended to be open-ended and mean that there may be additional elements other than the listed elements.

For purposes of the present invention, directional terms such as “top,” “bottom,” “upper,” “lower,” “above,” “below,” “left,” “right,” “horizontal,” “vertical,” “up,” “down,” etc., are used merely for convenience in describing the various embodiments of the present invention. The embodiments of the present invention may be oriented in various ways. For example, the diagrams, apparatuses, etc., shown in the drawing figures may be flipped over, rotated by 90° in any direction, reversed, etc.

For purposes of the present invention, a value or property is “based” on a particular value, property, the satisfaction of a condition, or other factor, if that value is derived by performing a mathematical calculation or logical decision using that value, property or other factor.

For purposes of the present invention, the term “comprising”, the term “having”, the term “including,” and variations of these words are intended to be open-ended and mean that there may be additional elements other than the listed elements.

For purposes of the present invention, it should be noted that to provide a more concise description, some of the quantitative expressions given herein are not qualified with the term “about.” It is understood that whether the term “about” is used explicitly or not, every quantity given herein is meant to refer to the actual given value, and it is also meant to refer to the approximation to such given value that would reasonably be inferred based on the ordinary skill in the art, including approximations due to the experimental and/or measurement conditions for such given value.

For purposes of the present invention, the term “batch weight” refers to total amount of materials inside an internal mixer.

For purposes of the present invention, the term “extrusion” refers to a process used to create objects of a fixed cross-sectional profile. Usually, during the process, a material is pushed through an extrusion die of the desired cross-section. Extrusion process has two main advantages over other manufacturing processes, which are its ability to create very complex cross-sections, and to work materials that are brittle, because the material only encounters compressive and shear stresses. It also forms parts with an excellent surface finish. Extrusion may be continuous (theoretically producing indefinitely long material) or semi-continuous (producing many pieces). The extrusion process can be done with the material hot or cold. Commonly extruded materials include metals, polymers, ceramics, concrete, modelling clay, and foodstuffs. The products of extrusion are generally called “extrudates.”

For purposes of the present invention, the term “glass transition temperature,” or Tg for short, refers to a temperature region where a polymer transitions from a hard, brittle material to a flexible semi-solid material. The Glass Transition Temperature (Tg) is different from a melting point (Tm).

For purposes of the present invention, the term “masterbatch” refers to a pre-prepared composition comprising pellets of a polymer and an additive. The percentage by weight of the additive in a masterbatch is much higher than that in an end-use mixture. The additive is generally properly dispersed in the polymer.

For purposes of the present invention, the term “room temperature” refers to a temperature of from about 20° C. to about 25° C.

For purposes of the present invention, the term “softening point” refers to a temperature at which a polymer softens beyond some arbitrary softness. Generally, the higher the softening point, the greater the molecular weight will be as long as the comparison is between resins with similar molecular composition.

For purposes of the present invention, the term “wetting” refers to the ability of a liquid to maintain contact with a solid surface, resulting from inter molecular interactions when the two are brought together.

### Description

While the invention is susceptible to various modifications and alternative forms, specific embodiment thereof has been shown by way of example in the drawings and will be described in detail below. It should be understood, however that it is not intended to limit the invention to the particular forms disclosed, but on the contrary, the invention is to cover all modifications, equivalents, and alternatives falling within the spirit and the scope of the invention.

Flexible and elastic plastic tubing are known in the art as shown in U.S. Pat. Nos. 3,070,132; 3,561,493; 3,605,750; 3,752,617; 3,825,036; 3,907,955; 4,276,250; 4,330,497; 4,662,404; 4,888,146; 5,258,160; 5,456,674; 5,533,985; and 6,036,682; European Patent. Nos. 385,730; 385,732; and 829,340; and Japanese Patent Nos. 304225 and 304226. Such described tubing is conventionally constructed from thermoplastic resins such as acrylic, nylon, polyvinyl chloride (PVC), polyolefin, polyethylene terephthalate (PET), thermoplastic rubber (TPR), polybutylene terephthalate (PBT), ethylene vinyl acetate (EVA), polycarbonate, polyvinylidene fluoride (PVDF), polyamide, polymethylmethacrylate (PMMA), and liquid crystal polymers (LCP).

Disclosed herein are various thermoplastic products which comprise thermoplastics modified with dispersed fluorocarbons. A thermoplastic product of the various thermoplastic products may be formed by an extrusion process from a melt-blended mixture comprising a substantially homogenously distributed thermoplastic polymer and a homogenously distributed fluorocarbon additive. The fluorocarbon additive has a lower surface energy than that of the thermoplastic polymer. As a result, the concentration of the fluorocarbon additive through a cross-section of the thermoplastic product of the various thermoplastic products is lower in the interior thereof and higher at the surfaces thereof.

This higher concentration of fluorocarbon additive at the surface of a thermoplastic product disclosed herein enables the provision of a thermoplastic product having heretofore unattainable properties. Thus, using very low concentrations of fluorocarbon additive, i.e., as low as 0.01% by weight, relatively high concentrations are attainable at the surface of the thermoplastic product disclosed herein. Accordingly, the fluorocarbon additive contained in a thermoplastic product may be in an amount no less than about 0.01%, by weight, of melt-blended mixture. The fluorocarbon may also be in an amount from about 0.01% to about 15%, by weight, of the melt-blended mixture.

The higher concentrations of fluorocarbon additive at the surfaces provide the various thermoplastic products with advantages of fluorocarbon-like surface properties, such as greater hydrophobicity, lower surface energy, non-adherent surface characteristics, more chemically inert, lower friction, smoother, etc. Accordingly, the thermoplastic products disclosed herein have lubricity surfaces. The thermoplastic products having lubricity surfaces may be further flexible and/or elastic. The thermoplastic products having lubricity surfaces may also be non flexible.

A unique advantage associated with the thermoplastic products of the invention is that, if cut, thermoplastic products in accordance with the present invention into plural sections, the fluorocarbon additive in the interior of the sections will migrate to the new surfaces formed by the cutting operation. In addition, the presence of the fluorocarbon additive enhances molding operations since it reduces “sticking” of the composition to the mold surfaces and enhances mold release. Also, the additive will, because of the lubricant properties thereof, permit higher speed processing for making extruded objects, i.e., films, sheets, tubing, and other profiles with particular cross-sectional shapes or patterns.

A wide variety of thermoplastic polymers may be utilized in making the thermoplastic products disclosed herein. In some embodiments, the thermoplastic polymers may be non flexible thermoplastic polymers. In some embodiments, the thermoplastic polymers may be flexible and/or elastomeric thermoplastic polymers. Flexible and/or elastomeric thermoplastic may be polyester elastomers including co-polyesters, polyether elastomers and blends thereof, styrene block copolymers, polypropylenes, polypropylene block copolymers, thermoplastic olefins (TPOs), thermoplastic vulcanizates (TPVs), thermoplastic polyurethanes, polyethylene as low molecular weight polyethylene, (LMWPE), medium molecular weight (MMWPE), high molecular weight, (HMWPE) and ultra high weight polyethylene, (UHMWPE). Flexible and/or elastomeric thermoplastic may also be plasticized polyvinyl chloride, polyamide-imides, fluoroelastics (PTFEs), including FEP, PFA, CTFE, ECTFE, ETFE), fluoroelastomers, flexible polyamides, ionomers, polybutadiene (PBD), ethylene-vinyl acetate (EVA), polybutylene (PB), polybutylene terephthalate (PBT), nitrile rubbers, natural rubbers, acrylonitrile-butadiene (nitride) rubber, and/or the like. The thermoplastic polymer may also be a polyolefin, olefin copolymer or block copolymer, polyether or polyamide polymer or polyether-polyamide block copolymer, vinyl polymer, polycarbonate, acrylic or methacrylic polymer, or mixtures thereof. The thermoplastic polymer may also be an ethylene-propylene, styrene-butadiene, styrene-butadiene-styrene, styrene-ethylene/butylene-styrene, styrene-butadiene-acrylonitrile (ABS), polyethylene terephthalate (PET), aromatic terephthalate or isophthlate, polymethylmethacrylate, polymethylacrylate, polybutylmethacrylate, polystyrene, or mixtures thereof. In some embodiments, the above described thermoplastic polymers and can also be nano structured thermoplastic polymers.

Another application of UHMWPE Polymers are useful in applications such as medical where human joints are fabricated from extruded profiles, such as rods, and bars implanted and improved by incorporating fluorocarbons as stated in this invention.

Fluorocarbon additives which may be employed in embodiments of the present invention include any fluorocarbon additive that have a surface energy substantially lower than that of a polymer with which it is compounded to ensure the high surface fluorine concentration described above.

For example, fluorocarbon additives may be suitable fluorocarbon oils, gums and greases. Suitable fluorocarbons oil may be fluorinated hydrocarbon polyether, fluorinated hydrocarbons, i.e., Aflunox® and Krytox®, or mixtures thereof.

A fluorocarbon additive may also be perfluorinated polyether (DuPont Fluoroguard® perfluorinated polyether). A fluorocarbon additive may also be perfluorinated polypropylene oxide. A fluorocarbon additive may further be perfluoropolyethylene oxide, perfluoropolypropylene oxide, polytetrafluoroethylene oligomers, perfluoropolyethylene-propylene, perfluoropolybutadiene oligomers, polyvinylidene fluoride oligomers and their copolymers and perfluorohydrocarbon oils such as perfluorocyclohexane, perfluorohexane, perfluorodocedane and higher molecular weight homologous linear or branched perfluorohydrocarbons or end linked perfluorohydrocarbons, and perfluorinated cyclic hydrocarbons and terminated derivatives thereof or co-polymers thereof, as well as other derivatives of perfluorocarbons.

The preferred fluorocarbon oils, gums and greases useful in embodiments of the present invention are characterized by having viscosities in the range of 20 to more than 50,000 centistokes at 20° C. The preferred fluorocarbon greases useful in embodiments of the present invention are characterized by having consistencies (as determined by ASTM D-217) in the range of NLGI grades 0 to 6. Preferred greases also include those made by mixing or blending fluoropolyether oils with perfluorhydrocarbons, such as those prepared from mixtures of Krytox®, Fluoroguard®, Fluoroether oils with Vydax® fluorotelomers are exemplary and explanatory only and are not restrictive of any subject matter claimed.

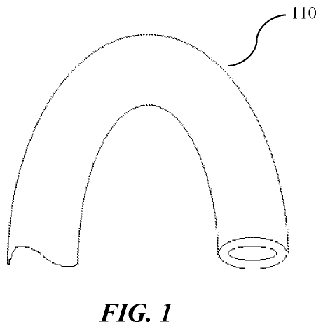

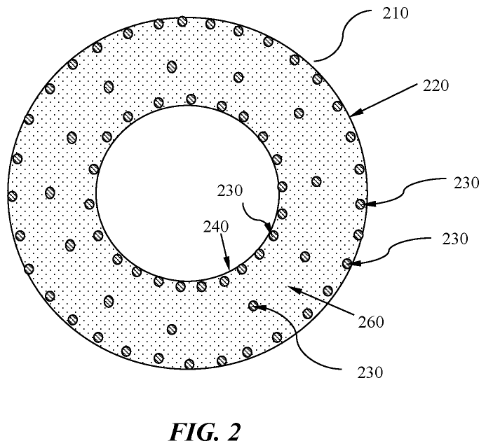

The above described thermoplastic products may be films, sheeting, tubing, and profiles with particular cross-sectional shapes, or any other thermoplastic objects having particular shapes. FIG. 1 illustrates an exemplary fragment of tubing (110) according to one embodiment of the present invention. FIG. 2 illustrates an exemplary cross-sectional view of tubing 110 in FIG. 1 according to one embodiment of the present invention. As shown in FIG. 2, the concentration of fluorocarbon additive 230 through the cross-section 210 of tubing 110 is higher at internal surface 240 and outside surface 220 and lower in interior 260 of tubing 110. It should be noted that the tubing shown in FIG. 1 and FIG. 2 are merely exemplary schematic illustrations of one embodiment. Tubing according to the embodiments of the present invention includes any other type of tubing that formed by extrusion from a mixture comprising thermoplastics modified with dispersed fluorocarbons, as described in various embodiments of the present invention.

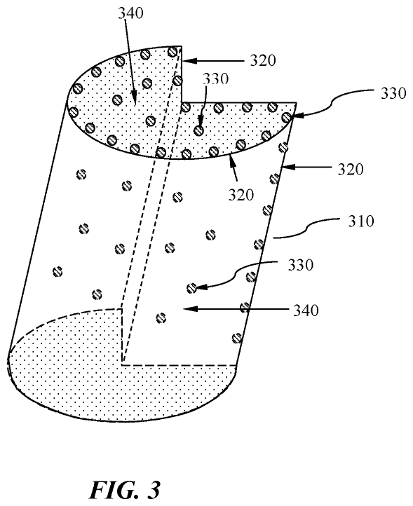

FIG. 3 is a schematic illustration showing a profile having a fixed cross-sectional shape according to one embodiment of the present invention. As shown in FIG. 3, the concentration of fluorocarbon additive 330 through the cross-section of profile 310 is higher at surface 320 and lower in interior 340 of profile 310. It should be noted that the profile shown in FIG. 3 is merely an exemplary schematic illustration of one of many profiles of the embodiments. Profiles according to the embodiments of the present invention include any other type of profile having a fixed cross-sectional shape that formed by extrusion from a mixture comprising thermoplastics modified with dispersed fluorocarbons, as described in various embodiments of the present invention.

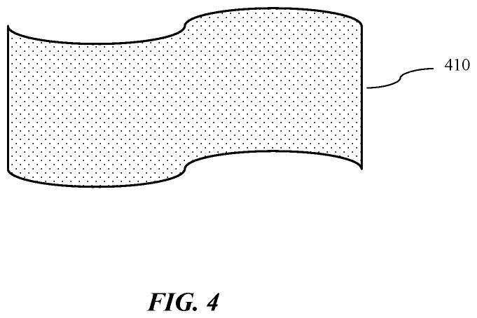

FIG. 4 is a schematic illustration showing a film according to one embodiment of the present invention. In film 410, the concentration of fluorocarbon additive through the cross-section of file 410 is higher at surface and lower in the interior of film 410. It should be noted that the film shown in FIG. 4 is merely an exemplary schematic illustration of one of the embodiments. A film according to the embodiments of the present invention include any other type of film having a fixed cross-sectional shape that formed by extrusion from a mixture comprising thermoplastics modified with dispersed fluorocarbons, as described in various embodiments of the present invention.

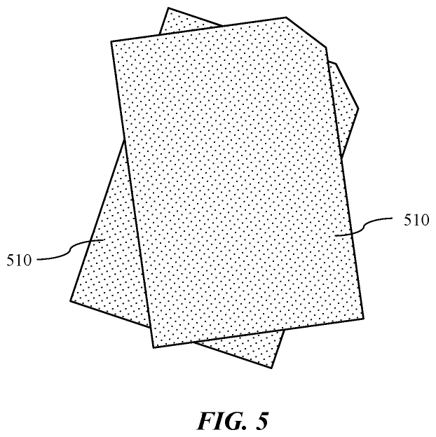

FIG. 5 is a schematic illustration showing a sheet according to one embodiment of the present invention. In sheet 510, the concentration of fluorocarbon additive through the cross-section of sheet 510 is higher at surface and lower in the interior thereof. It should be noted that the sheet shown in FIG. 5 is merely an exemplary schematic illustration of one of the embodiments. A sheet according to the embodiments of the present invention include any other type of sheet having a fixed cross-sectional shape that formed by extrusion from a mixture comprising thermoplastics modified with dispersed fluorocarbons, as described in various embodiments of the present invention.

All of the tubing, profiles, films, sheeting shown in FIGS. 1 through 5 have properties described above with respect to the thermoplastic products comprising thermoplastics modified with dispersed fluorocarbons. For example, all of the tubing, profiles, films, sheeting shown in FIGS. 1 through 5 are flexible and/or elastic and have lubricity surfaces.

Embodiments further provide a method for making the above described tubing, profiles, films, sheeting, and other types of thermoplastic products containing the fluorocarbon additive.

In some embodiments, the method for making a thermoplastic product described herein is a process including extrusion. In particular, a melt-blended mixture comprising a thermoplastic polymer and a fluorocarbon additive is extruded through an extruding die, thereby producing an extrudate comprising the thermoplastic polymer and the fluorocarbon additive and having a shape. The thermoplastic polymer and the fluorocarbon additive are substantially homogenously distributed throughout the melt-blended mixture. Upon cooling, the extrudate forms into a solid thermoplastic product, comprising the thermoplastic polymer and the fluorocarbon additive. The shape of the solid polymer is shaped according to the shape of the extruding die. A thermoplastic product prepared by this process has a lubricity surface. In some embodiments, a thermoplastic product prepared by this process may be non flexible and has a lubricity surface. In some embodiments, a thermoplastic product prepared by this process may be flexible and/or elastic and has a lubricity surface.

The process further includes a step of melt-blending the thermoplastic polymer and the fluorocarbon additive at a temperature for a sufficient time before extruding, thereby resulting in a melt-blended mixture comprising the thermoplastic polymer and the fluorocarbon additive that are substantially homogenously distributed throughout the melt-blended mixture, i.e., a substantially homogenous blend. The temperature for melt-blending the thermoplastic polymer and the fluorocarbon additive depends on the types of the thermoplastic polymer and the fluorocarbon additive. A suitable temperature for conducting the melt-blending is above a glass transition temperature or a softening point of the thermoplastic polymer but below a decomposition temperature of both the thermoplastic polymer and the fluorocarbon additive, such that a suitable temperature should not have deleterious effect on the thermoplastic polymer and the fluorocarbon additive.

As described above, a wide variety of thermoplastic polymers may be utilized in making the thermoplastic products disclosed herein. In some embodiments, the thermoplastic polymers may be any non flexible polymers and/or any elastomeric thermoplastic polymers. thermoplastic polymers may be polyester elastomers including co-polyesters, polyether elastomers and blends thereof, styrene block copolymers, polypropylenes, polypropylene block copolymers, thermoplastic olefins (TPOs), thermoplastic vulcanizates (TPVs), thermoplastic polyurethanes, polyethylene, plasticized polyvinyl chloride, polyamide-imides, fluoroelastics (PTFEs), including FEP, PFA, CTFE, ECTFE, ETFE), fluoroelastomers, flexible polyamides, ionomers, polybutadiene (PBD), ethylene-vinyl acetate (EVA), polybutylene (PB), polybutylene terephthalate (PBT), nitrile rubbers, natural rubbers, acrylonitrile-butadiene (nitride) rubber, and/or the like. The thermoplastic polymer may also be a polyolefin, olefin copolymer or block copolymer, polyether or polyamide polymer or polyether-polyamide block copolymer, vinyl polymer, polycarbonate, acrylic or methacrylic polymer, or mixtures thereof. The thermoplastic polymer may also be an ethylene-propylene, styrene-butadiene, styrene-butadiene-styrene, styrene-ethylene/butylene-styrene, styrene-butadiene-acrylonitrile (ABS), polyethylene terephthalate (PET), aromatic terephthalate or isophthlate, polymethylmethacrylate, polymethylacrylate, polybutylmethacrylate, polystyrene, or mixtures thereof. In some embodiments, the above described thermoplastic polymers may be nano structured thermoplastic polymers.

A fluorocarbon additive employed in above described embodiments of the present invention includes any fluorocarbon additive that have a surface energy substantially lower than that of a thermoplastic polymer with which it is melt-blended to ensure the high surface fluorine concentration described above. For example, suitable fluorocarbon additives may be fluorocarbon oils, gums, and greases. Suitable fluorocarbon oils may be fluorinated hydrocarbon polyether, fluorinated hydrocarbons, i.e., Aflunox® and Krytox®, or mixtures thereof. The preferred fluorocarbon oils, gums and greases useful in embodiments of the present invention are characterized by having viscosities in the range of 20 to more than 50,000 centistokes at 20° C. The preferred fluorocarbon greases useful in embodiments of the present invention are characterized by having consistencies (as determined by ASTM D-217) in the range of NLGI grades 0 to 6. The preferred greases also include those made by mixing or blending fluoropolyether oils with perfluorhydrocarbons, such as those prepared from mixtures of Krytox®, Fluoroguard®, Fluoroether oils with Vydax® fluorotelomers are exemplary and explanatory only and are not restrictive of any subject matter claimed.

A fluorocarbon additive may also be perfluorinated polyether (DuPont Fluoroguard® perfluorinated polyether), now assigned to Chemours Company. A fluorocarbon additive may also be perfluorinated polypropylene oxide. A fluorocarbon additive may further be perfluoropolyethylene oxide, perfluoropolypropylene oxide, polytetrafluoroethylene oligomers, perfluoropolyethylene-propylene, perfluoropolybutadiene oligomers, polyvinylidene fluoride oligomers and their copolymers and perfluorohydrocarbon oils such as perfluorocyclohexane, perfluorohexane, perfluorodocedane and higher molecular weight homologous linear or branched perfluorohydrocarbons or end linked perfluorohydrocarbons, and perfluorinated cyclic hydrocarbons and terminated derivatives thereof or co-polymers thereof, as well as other derivatives of perfluorocarbons.

To facilitate uniformly mixing the fluorocarbon additive with the thermoplastic polymer, it is preferred to employ small particle sizes (e.g., pellets or powders) of the thermoplastic polymer. In some embodiments, the small particle sizes of powders are 3 to 10 microns. Employment of small particle sizes of the thermoplastic polymer ensures efficient wetting of the polymer particle surface prior to melt-blending, thereby ensuring efficient dispersion of the additive throughout the polymer.

In some embodiments, melt-blending apparatus which ensures substantially homogenous mixing of the ingredients is required. It has been found that a twin-screw compounding blender/extruder is particularly advantageous over single screw and is therefore preferred for carrying out the method of making the thermoplastic products described herein. In some embodiments, the melt-blending step is performed in a compounding extruder or blender followed by directly extruding to form a thermoplastic product such as tubing, films, sheeting, and profiles.

The above described method may further include additional steps of preparing a mixture of the fluorocarbon additive and the thermoplastic polymer before melt-blending. The fluorocarbon additive may be in an amount about 0.01% to about 15%, by weight, of the total batch weight of the mixture.

Generally, at least four approaches may be used to prepare a mixture used for melt-blending. One approach is to pre-mix a small fraction of the total amount of the thermoplastic polymer that is needed with the total amount of the fluorocarbon additive that is needed, thereby forming a pre-mix. The pre-mix is further mixed with the rest of the thermoplastic polymer to form a final mixture for melt-blending. The final mixture includes the total amount of the thermoplastic polymer and the fluorocarbon additive needed, which has a batch weight. The amount of the fluorocarbon additive added for forming a pre-mix is determined based on a percentage of the fluorocarbon additive in the batch weight of the final mixture.

In preferred embodiments, before melt-blending, the fluorocarbon additive is uniformly premixed or wetted with a small fraction of the thermoplastic polymer in particulate form such as pellets or powders, thereby forming a pre-mixture comprising the fraction of the thermoplastic polymer in particulate form uniformly wetted with the fluorocarbon additive. Subsequently, the wetted fraction of the pre-mixture, or the first pre-mixture, is then admixed with the remainder of the thermoplastic polymer, thereby producing a second pre-mixture, which is subsequently melt-blended in an efficient high shear compounding extruder such as a twin-screw compounding extruder-blender.

Another approach is to directly mix the total amount of the fluorocarbon additive needed with the total amount of the thermoplastic polymer need, thereby forming a mixture for melt-blending and extrusion.

Alternatively, master-batch methods may be advantageously used in which high shear melt blended mixture containing higher concentrations of fluorocarbon additive are admixed with a virgin thermoplastic polymer for extrusion or molding. A virgin thermoplastic polymer is a thermoplastic polymer not blended with an additive. In particular, a master-batch of prepared pellets comprises pellets of the thermoplastic polymer melt-blended with the fluorocarbon additive, in which the fluorocarbon additive is dispersed at a higher percentage, by weight, than that in a final mixture for melt-blending and extrusion. The masterbatch of prepared pellets and the virgin thermoplastic polymer may be directly fed into an extruder material hopper by a gravimetric feeder, forming a mixture and being blended in the extruder material hopper. The amount of the masterbatch of prepared pellets fed into the extruder material hopper is determined based on the percentage of the fluorocarbon additive, by weight, in the batch weight of the mixture of the masterbatch and the virgin thermoplastic polymer.

Alternatively, a thermoplastic polymer may be fed into a twin-screw compounding blender/extruder. A fluorocarbon additive, such as a fluorocarbon oil, may be directly fed in an extruder screw zone of the twin-screw compounding blender/extruder by a metering pump and be mixed with the thermoplastic polymer in the twin-screw compounding blender/extruder.

In the above described embodiments, the fluorocarbon additive may in an amount about 0.01% to about 15%, by weight, of the melt-blended mixture. The fluorocarbon additive contained in the thermoplastic product has a lower surface energy than that of the thermoplastic polymer. As a result, the concentration of the fluorocarbon additive through a cross-section of the solid thermoplastic product is lower in the interior thereof and higher at the surfaces thereof. In other words, the concentration of the fluorocarbon additive is in a gradient through a cross-section of the solid thermoplastic product from a lower value in the interior or bulk thereof to a higher value at the surfaces thereof. In the phrase “concentration of the fluorocarbon additive in a gradient through a cross-section from a lower value at the center thereof to a higher value at the surfaces,” the term “gradient” is not intended to suggest that the concentration varies uniformly from the center of the thermoplastic product to the surface thereof. Although this may be the case with respect to some combination of polymers and additive, typically a much higher concentration of the additive is at the surfaces of the thermoplastic product with a much smaller amount in the interior or bulk of the thermoplastic product.

When the thermoplastic products containing the fluorocarbon additive described herein are correctly prepared, they exhibit enhanced chemical and mechanical properties and specifications. These thermoplastic products such as tubing have advantageous properties not suggested by the prior art.

For example, some advantageous of the thermoplastic tubing include improved tensile strength and tensile elongation. Not only tubing resiliency, but also surface lubricity is vital when used in, e.g., roller pump applications. The fluorocarbon additives provide the requisite lubricity to the tubing, which lubricity remains on the surfaces thereof by its being continuously exuded from the surfaces. Other applications for the tubing of the invention include medical, general indusial, automotive and environmental.

Other desirable properties of the fluorocarbon additives when incorporated in polymers include better disbursement of fillers, powders, and reinforcements when used in tubing applications. The uniformity of the dispersion of the particulates with the addition of fluorocarbon additive greatly improves the extrudate polymer performance.

The disclosed invention is further defined in the following non-limiting examples. In these examples, all percentages are by weight except as otherwise indicated.

These examples are given by way of illustration only. From the above discussion and these examples, one skilled in the art can ascertain the essential characteristics of embodiments of the disclosed invention. Without departing from the spirit and scope thereof, one skilled in the art can make various changes and modifications of the invention to adapt it to various usages and conditions. All publications, including patents and non-patent literature, referred to in this specification are expressly incorporated by reference herein.

### EXAMPLES

### Example 1

This example illustrates exemplary tubing made with Fluorocarbon and Styrene-olefin Block Copolymer (SEBS). The tubing is fabricated according to the above described method. In this example, the material used for making the tubing in one sample comprises 0.05%, by weight, of Fluorocarbon, i.e., Perfluorinated Polyether (DuPont Fluoroguard®) Perfluorinated Polyether), and SEBS Polymer. The percentage of the fluorocarbon additive is based on the total batch weight of the mixture of the fluorocarbon and SEBS polymer. The physical property specifications of the exemplary tubing are shown in Table 1.

TABLE 1
Physical Property Specifications

| | Thermoplastic Elastomers Styrenic Type (SEBS) | | | |
|---|---|---|---|---|
| | | Sample 1 | Sample 2 | Sample 3 |
| | Perfluorinated Polyether % | | | |
| | Amount | | | |
| | Standard Test | | | |
| | Method | 0.03% | 0.05% | 0% |
| Specific Gravity | ASTM D-792 | .90 | .90 | 0.88 |
| Shrinkage (%) | ASTM D-955 | 0.0152 | 0.0153 | 0.155 |
| Ult. Tensile | ASTM D-412 | 823 | 1036 | 775 |
| Strength (psi) | | | | |
| Ult. Tensile | ASTM D-412 | 1169 | 1284 | 650 |
| Elongation (%) | | | | |
| Hardness (Shore A) | ASTM D-2240 | 50 | 50 | 50 |

The above materials were primarily developed for use in peristaltic pump tubing applications. These polymers are designed to deliver excellent tubing resilience and flex life when used in peristaltic pumps. The polymers, formulated with DuPont Fluoroguard® perfluorinated polyether additive, will also reduce the wear of the pump tubing against contact of the stainless rollers, and add consistent surface lubricity.

### Example 2

Thermoplastic elastomers, polyether/block polyamide Type (PEBA).

The following table 2 illustrates the properties of exemplary tubing comprising different amount of perfluoropolyether (PFPE). In particular, different samples of tubing comprising various amount of PFPE, by weight, are respectively shown as A1, D1, and D2 in Table 2. In this example, sample A1 contains 0 wt % of PFPE. Sample D1 comprises about 0.2%, by weight, of PFPE. Sample D2 comprises about 0.5%, by weight, based on the total batch weight of the mixture, of PFPE.

TABLE 2
Thermoplastic Elastomers, Polyether/block
Polyamide Type (PEBA)

| | | Sample | | |
|---|---|---|---|---|
| | | A1 | D1 | D2 |
| PFPE* % by weight | | 0 | 0.2 | 0.5 |
| | Standard Test | Sample | | |
| Material Property | Method | A1 | D1 | D2 |
| Specific Gravity | D 792 | 1.01 | 1.01 | 1.01 |
| Tensile Strength (psi) | D 412 | 2066 | 2165 | 2385 |
| Tensile Elongation (%) | D 412 | 1538 | 1540 | 1620 |
| Tear Strength (pli) | D 624 (Die C) | 420 | 476 | 480 |
| Hardness (Sh. A/Sh. D) | D2240 | 79/26 | 75/26 | 73/26 |

*Fluoroguard ® perfluorinated polyether

This exemplary tubing is useful in applications such as medical where human joints are fabricated from extruded profiles, such as rods, and bars implanted and improved by incorporating fluorocarbons as stated in this invention.

### Example 3

This example illustrates the properties of exemplary tubing comprising different amount of perfluoropolyether (PFPE). The exemplary tubing comprises thermoplastic elastomers, olefinic type (TPO).

TABLE 3
Thermoplastic Elastomers, Olefinic Type (TPO)

| | Standard Test | | |
|---|---|---|---|
| | Method | Sample 1 | Sample 2 |
| PFPE % by weight | | 0.03% | 0 |
| Specific Gravity | ASTM D-792 | .096 | .90 |
| Shrinkage (%) | ASTM D-955 | 3.12 | 2.03 |
| Specific Gravity | ASTM D-792 | .096 | .90 |
| Ult. Tensile Strength (psi) | ASTM D-412 | 536 | 320 |
| Ult. Tensile Elongation (%) | ASTM D-412 | 540 | 412 |
| Hardness (Shore A) | ASTM D-2240 | 50 | 45 |

This exemplary tubing is useful in applications such as medical where human joints are fabricated from extruded profiles, such as rods, and bars implanted and improved by incorporating fluorocarbons as stated in this invention.

Having described the many embodiments of the present invention in detail, it will be apparent that modifications and variations are possible without departing from the scope of the invention defined in the appended claims. Furthermore, it should be appreciated that all examples in the present disclosure, while illustrating many embodiments of the invention, are provided as non-limiting examples and are, therefore, not to be taken as limiting the various aspects so illustrated.

The following references are referred to above and are incorporated herein by reference:

1. U.S. Pat. No. 5,143,963, Thermoplastic polymers with dispersed fluorocarbon additives.
2. U.S. Pat. No. 5,286,773, Thermoplastic polymers with dispersed fluorocarbon additives.
3. U.S. Pat. No. 6,087,430, Thermoplastic polymers with dispersed fluorocarbon additives.
4. U.S. Pat. No. 6,541,558, Thermoplastic polymers with dispersed fluorocarbon additives.
5. U.S. Pat. No. 5,912,291, Thermoplastic polymers with polyfluoroalkylsiloxane modified surfaces.
6. U.S. Pat. No. 6,841,602, Thermoplastic polymers with polyfluoroalkylsiloxane modified surfaces.

All documents, patents, journal articles and other materials cited in the present application are incorporated herein by reference.

While the present invention has been disclosed with references to certain embodiments, numerous modification, alterations, and changes to the described embodiments are possible without departing from the sphere and scope of the present invention, as defined in the appended claims. Accordingly, it is intended that the present invention not be limited to the described embodiments, but that it has the full scope defined by the language of the following claims, and equivalents thereof.

What is claimed is:

1. A thermoplastic product made by a process comprising:
extruding a melt-blended mixture comprising a thermoplastic polymer and a fluorocarbon additive through an extruding die, thereby producing an extrudate comprising the thermoplastic polymer and the fluorocarbon additive; and
cooling the extrudate, thereby forming a solid thermoplastic product comprising the thermoplastic polymer and the fluorocarbon additive and having a particular shape;
wherein the thermoplastic polymer and the fluorocarbon additive are substantially homogenously distributed in the melt-blended mixture;
wherein the fluorocarbon additive has a lower surface energy than that of the thermoplastic polymer;
wherein a concentration of the fluorocarbon additive through a cross-section of the solid thermoplastic product is lower in an interior and higher at a surface thereof; and
wherein the solid thermoplastic product has a lubricity surface.

2. The thermoplastic product of claim 1, wherein the melt-blended mixture is prepared by:
mixing a fraction of the thermoplastic polymer in particulate form with the fluorocarbon additive, thereby producing a first pre-mixture comprising the thermoplastic polymer in particulate form uniformly wetted with the fluorocarbon additive;
mixing the first pre-mixture with a remainder of the thermoplastic polymer, thereby producing a second pre-mixture comprising the thermoplastic polymer and the fluorocarbon additive;
melt-blending the second pre-mixture at a temperature for a sufficient time that allows the fluorocarbon additive to be uniformly blended with the thermoplastic polymer, thereby forming the melt-blended mixture in which the thermoplastic polymer and the fluorocarbon additive are substantially homogenously distributed; and
wherein the temperature is above a glass transition temperature or a softening point of the thermoplastic polymer but below a point that has a deleterious effect on the thermoplastic polymer and the fluorocarbon additive.

3. The thermoplastic product of claim 1, wherein the thermoplastic product is tubing.

4. The thermoplastic product of claim 1, wherein the thermoplastic product is a film.

5. The thermoplastic product of claim 1, wherein the thermoplastic product is sheeting.

6. The thermoplastic product of claim 1, wherein the thermoplastic product is a profile having a particular cross-sectional shape.

7. The thermoplastic product of claim 1, wherein the fluorocarbon additive is in an amount from about 0.01% to about 15%, by weight, of the melt-blended mixture.

8. The thermoplastic product of claim 1, wherein the fluorocarbon additive comprises a fluorocarbon oil.

9. The thermoplastic product of claim 8, wherein the fluorocarbon oil is selected from the group consisting of fluorinated hydrocarbon polyether, fluorinated hydrocarbons, and mixtures thereof.

10. The thermoplastic product of claim 1, wherein the fluorocarbon additive is a perfluorinated polyether.

11. The thermoplastic product of claim 1, wherein the fluorocarbon additive is perfluorinated polypropylene oxide.

12. The thermoplastic product of claim 1, wherein the fluorocarbon additive is a fluorocarbon gum.

13. The thermoplastic product of claim 1, wherein the fluorocarbon additive is fluorocarbon grease.

14. The thermoplastic product of claim 1, wherein the fluorocarbon additive is a fluorinated hydrocarbon, fluorinated hydrocarbon polyether, Aflunox, Krytox, perfluoropolyethylene oxide, perfluoropolypropylene oxide, polytetrafluoroethylene, perfluoropolyethylene-propylene, perfluoropolybutadiene oligomers, polyvinylidene fluoride oligomers and their copolymers, perfluorocyclohexane, perfluorohexane; perfluorodocedane, homologous linear or branched or end linked perfluorohydrocarbon, perfluorinated cyclic hydrocarbon and terminated derivatives thereof or co-polymers thereof, or mixtures thereof.

15. The thermoplastic product of claim 1, wherein the thermoplastic polymer is a polyolefin, olefin copolymer or block copolymer, polyether or polyamide polymer or polyether-polyamide block copolymer, polyester, vinyl polymer, polycarbonate, polyurethane, acrylic or meth acrylic polymer, or mixtures thereof.

16. The thermoplastic product of claim 1, wherein the thermoplastic polymer is a polyethylene, polypropylene, ethylene-propylene, styrene-butadiene, styrene-butadiene-styrene, styrene-ethylene/butylene-styrene, styrene-butadiene-acrylonitrile (ABS), polyethylene terephthalate (PET), polybutylene terephthalate (PBT), aromatic terephthalate or isophthlate, polymethylmethacrylate, polymethylacrylate, polybutylmethacrylate, polyvinyl chloride, polystyrene, or mixtures thereof.

17. A method of forming a thermoplastic product comprising:
melt-blending a thermoplastic polymer and a fluorocarbon additive at a temperature for a sufficient time to produce a substantially homogenous blend of the thermoplastic polymer and the fluorocarbon additive;
extruding the substantially homogenous blend through an extruding die, thereby forming an extrudate comprising the thermoplastic polymer; and
cooling the extrudate to allow the extrudate forms into a solid thermoplastic product having a particular shape;
wherein the temperature is above a glass transition temperature or a softening point of the thermoplastic polymer but below a point that has a deleterious effect on the thermoplastic polymer and the fluorocarbon additive;
wherein a concentration of the fluorocarbon additive through a cross-section of the solid thermoplastic product is lower in interior thereof and higher at surface thereof; and
wherein the solid thermoplastic product has a lubricity surface.

18. The method of claim 17, further comprising additional steps before melt-blending the thermoplastic polymer and the fluorocarbon additive, wherein the additional steps comprising:
mixing a fraction of the thermoplastic polymer in particulate form with the fluorocarbon additive, thereby forming a first pre-mixture comprising the fraction of the thermoplastic polymer in particulate form uniformly wetted with the fluorocarbon additive; and
admixing the first pre-mixture with a remainder of the thermoplastic polymer, thereby producing a second pre-mixture of the thermoplastic polymer and the fluorocarbon additive, wherein the second pre-mixture is subsequently melt-blended to produce a substantially homogenous blend of the thermoplastic polymer and the fluorocarbon additive.

19. The method of claim 17, wherein the melt-blending is performed in a compounding extruder or blender followed by directly extruding to form the thermoplastic product.
